(19) United States
(12) Patent Application Publication
(10) Pub. No.: US 2010/0017290 A1
(43) Pub. Date: Jan. 21, 2010

(54) APPARATUS, METHOD AND PROGRAM FOR ATTACHING ADVERTISEMENT

(75) Inventor: Yuko MATSUI, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: FUJIFILM Corporation, Tokyo (JP)

(21) Appl. No.: 12/570,940

(22) Filed: Sep. 30, 2009

(30) Foreign Application Priority Data
Jan. 10, 2008 (JP) 2008-256260

(51) Int. Cl. G06Q 30/00

(52) U.S. Cl. 705/14.52; 705/14.53

(57) ABSTRACT

An image feature extractor of a server extracts a feature quantity of an input image from a client terminal. A keyword obtaining section obtains a keyword of the input image based on the feature quantity. A related image retriever retrieves a related image based on the keyword of the input image. The image feature extractor also extracts a feature quantity of the related image. The keyword obtaining section also obtains a keyword of the related image based on the feature quantity of the related image. An advertisement retriever retrieves an advertisement based on the keyword of the input image and the keyword of the related image. The input image, the keyword of the input image, the related image, the keyword of the related image and the advertisement are transmitted to the client terminal and displayed on its monitor.

### FIELD OF THE INVENTION

The present invention relates to an apparatus, a method and a program for attaching an advertisement, relevant to an input image and/or a related image searched based on the input image, to the related image.

### BACKGROUND OF THE INVENTION

Keyword advertisements are common on the Internet. The keyword advertisements are advertisements related to a keyword input as a search term at a search site such as Yahoo! (registered trademark) or Google (registered trademark). At the search site, one or more related keyword advertisements are extracted based on the keyword. The extracted advertisements are attached to a search result and transmitted to a client terminal. The search result and the keyword advertisements are displayed on a monitor of the client terminal. The keyword advertisements are used in various ways. The keyword advertisements may be displayed at a chat site that allows users to communicate in real time. For example, in methods described in Japanese Patent Laid-Open Publication No. 2000-194728, keyword advertisements associated with keywords contained in chat messages are displayed on a chat screen.

Besides the keywords, for example, in methods described in Japanese Patent Laid-Open Publication No. 2002-329191, GPS information attached to an image is obtained. In association with the GPS information, advertisements of locations such as tourist attractions are attached to a search result.

To search images, an image itself can be used as a search query for the search. For example, in methods described in Japanese Patent Laid-Open Publication No. 08-249467 and U.S. Pat. No. 6,249,607 (corresponding to Japanese Patent Laid-Open Publication No. 11-096368), a feature quantity is extracted from an input image, and related images are searched based on the extracted feature quantity.

To attach advertisements based on GPS information of an image as described in the methods of Japanese Patent Laid-Open Publication No. 2002-329191, the image is required to have GPS information. However, since a level of utilization of images with GPS information is low and the GPS information is easily lost, the above described methods lack robustness.

In Japanese Patent Laid-Open Publication No. 08-249467 and U.S. Pat. No. 6,249,607, the search can be carried out using an image as a search key and based on its feature quantity, but it is impractical to attach keyword advertisements to the search results.

### SUMMARY OF THE INVENTION

An object of the present invention is to provide an apparatus, a method and a program for attaching an advertisement related directly or indirectly to an image as a search key.

In order to achieve the above and other objects, an advertisement attaching apparatus according to the present invention includes an image feature extractor, a related image retriever, an advertisement retriever, and a transmitting section. The image feature extractor extracts a first feature quantity from an image sent from a client terminal. The related image retriever retrieves a related image related to the image based on the first feature quantity. The advertisement retriever retrieves an advertisement related to the image and/or the related image. The transmitting section transmits the related image and the advertisement to the client terminal. The advertisement attaching apparatus is connected to the client terminal via the Internet.

It is preferable that the image feature extractor extracts a second feature quantity from the related image, in addition to the first feature quantity.

It is preferable that the advertisement attaching apparatus further includes a keyword obtaining section for obtaining a keyword from the first feature quantity and/or the second feature quantity. It is preferable that the advertisement retriever retrieves the advertisement from an advertisement database based on the keyword.

It is preferable that the keyword obtaining section obtains a keyword based on the first feature quantity. It is preferable that the related image retriever retrieves the related image from an image database based on the keyword.

It is preferable that the first or second feature quantity is information of a human face.

It is preferable that the keyword obtaining section uses a personal name table list in which a plurality of human faces and their names are associated with each other and stored, and obtains a name, corresponding to the human face, as the keyword.

It is preferable that the first or second feature quantity is information of a product.

It is preferable that the keyword obtaining section uses a product table list in which a plurality of products and their names are associated with each other and stored, and obtains a name, corresponding to the product, as the keyword.

It is preferable that the first or second feature quantity is alphanumeric information.

It is preferable that the first or second feature quantity is a combination of colors, and the keyword obtaining section uses a table list in which a plurality of color combinations and description terms suggested by the color combinations are associated with each other and stored, and obtains a description term, corresponding to the color combination, as the keyword.

It is preferable that the advertisement retriever accesses the advertisement database which stores advertisements associated with the keywords and retrieves the advertisement.

An advertisement attaching apparatus includes an image feature extractor, a related image retriever, a keyword obtaining section, an advertisement retriever and a monitor. The image feature extractor extracts a first feature quantity from an input image. The related image retriever retrieves a related image related to the image based on the first feature quantity. The keyword obtaining section obtains a keyword from the image and/or the related image. The advertisement retriever retrieves an advertisement from a server based on the keyword. The monitor displays the related image and the advertisement. The advertisement attaching apparatus is connected to the server via the Internet.

An advertisement attaching method includes an extracting step, a related image retrieving step, an advertisement retrieving step and a transmitting step. In the extracting step, a feature quantity of an image received from a client terminal via the Internet is extracted. In the related image retrieving step, a related image related to the image are retrieved. In the advertisement retrieving step, an advertisement is retrieved based on the feature quantity. In the transmitting step, the advertisement is transmitted together with the related image to the client terminal.

An advertisement attaching program of the present invention causes a computer to execute the advertisement attaching method of the present invention.

Thus, according to the present invention, the advertisement is attached based on the image input as the search key.

### BRIEF DESCRIPTION OF THE DRAWINGS

The above and other objects and advantages of the present invention will be more apparent from the following detailed description of the preferred embodiments when read in connection with the accompanied drawings, wherein like reference numerals designate like or corresponding parts throughout the several views, and wherein:

FIG. 1 is a schematic view of a network system;

FIG. 2 is a block diagram showing an internal configuration of a client terminal;

FIG. 3 is a block diagram showing an internal configuration of a server;

FIG. 4 is an explanatory view of a search result screen; and

FIG. 5 is a flowchart showing processing steps for attaching an advertisement.

### DESCRIPTION OF THE PREFERRED EMBODIMENTS

### First Embodiment

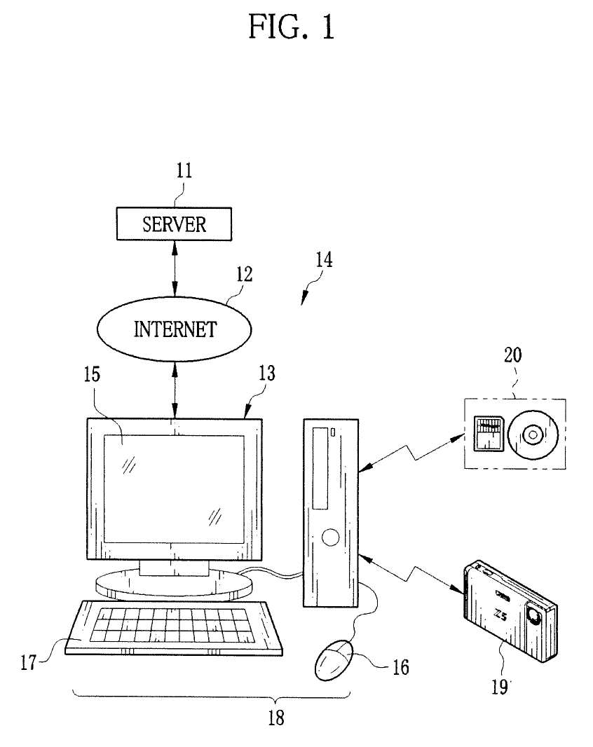

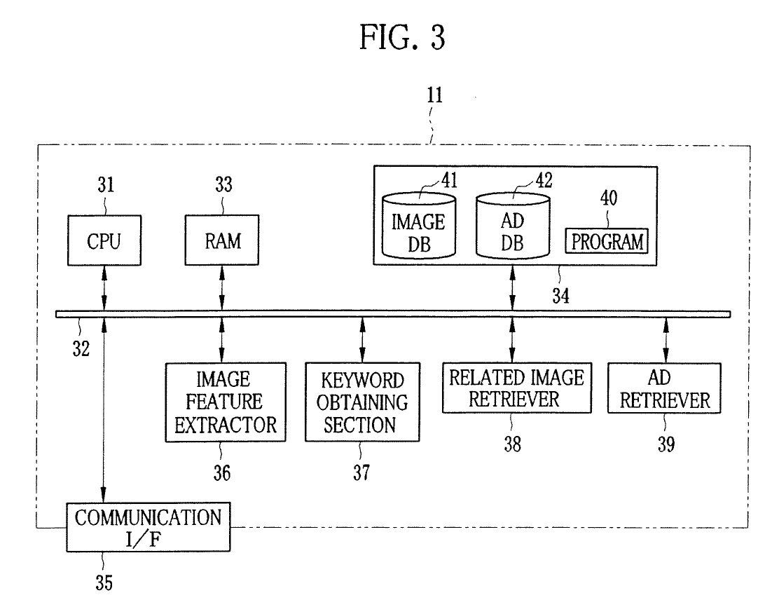

In FIG. 1, an advertisement attaching apparatus in an Internet advertising system is implemented by a server 11 installed with an advertisement attaching program 40 (see FIG. 3). The advertisement attaching apparatus searches an image (hereinafter referred to as related image) related to an image (hereinafter referred to as input image) received from a client terminal 13, and retrieves an advertisement based on a feature quantity of the input image. Information containing the input image, the related image and the attached advertisement are transmitted to the client terminal 13 via the Internet 12. The client terminal 13 displays the input image, the related image (the search result) and the advertisement on a monitor 15.

A network system 14 is composed of the server 11, the Internet 12 and the client terminal 13. The server 11 and the client terminal 13 are connected via the Internet 12. The client terminal 13 is a well-known personal computer or a work station, for example. The client terminal 13 is provided with the monitor 15 and an operating section 18. The monitor 15 displays various operation screens. The operating section 18 is composed of a mouse 16 and a keyboard 17 that output operation signals.

Images taken with a digital camera 19 or images stored in a recording medium 20 such as a memory card or a CD-R are input as the input images to the client terminal 13. The input images are transmitted as search query images to the server 11 through the Internet 12.

The digital camera 19 is connected to the client terminal 13 to communicate data between each other via wireless LAN or a communication cable complying with IEEE 1394 or USB (Universal Serial Bus), for example. The client terminal 13 and the recording medium 20 communicate data between each other via a dedicated driver (not shown).

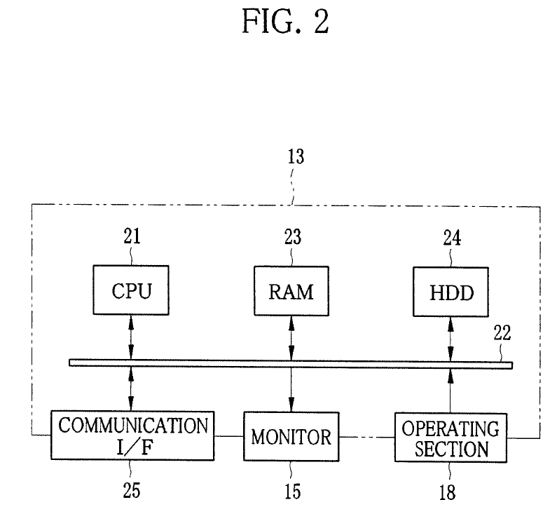

As shown in FIG. 2, the client terminal 13 has a CPU 21. The CPU 21 controls the entire client terminal 13 according to operating instructions from the operating section 18. In addition to the operating section 18, a RAM 23, a hard disk drive (HDD) 24, a communication interface (I/F) 25 and the monitor 15 are connected to the CPU 21 via a data bus 22.

The RAM 23 is a work memory for the CPU 21 to execute processing. Various programs and data for running the client terminal 13 are stored in the HDD 24. In addition, the images imported from the digital camera 19, the recording medium 20 and/or the Internet 12 are also stored in the HDD 24. The CPU 21 reads the program from the HDD 24 and expands it in the RAM 23, and serially processes the read program.

The communication I/F 25 is, for example, a modem or a router. The communication I/F 25 controls communication protocol suitable for the Internet 12, and communicates data via the Internet 12. The communication I/F 25 also allows data communications with data input devices such as the digital camera 19 and the recording medium 20.

As shown in FIG. 3, the server 11 is provided with a CPU 31, and the CPU 31 controls the entire server 11 based on requests from the client terminal 13 via the Internet 12. To the CPU 31 are connected, via a data bus 32, a RAM 33, a hard disk drive (HDD) 34, a communication interface (I/F) 35, an image feature extractor 36, a keyword obtaining section 37 or descriptor generator, a related image retriever 38, and an advertisement retriever (ad retriever) 39.

The RAM 33 is a work memory for the CPU 31 to execute processing. Various programs and data for running the server 11 are stored in the HDD 34. In addition, the advertisement attaching program 40 is stored in the HDD 34. The CPU 31 reads the program from the HDD 34 and expands it in the RAM 33, and serially processes the read program.

The HDD 34 is provided with an image database (image DB) 41 and an advertisement database (ad DB) 42. In the image DB 41 are stored an image table list and a keyword table list (both not shown) together with a plurality of image data.

The image table list stores file names of the images using IDs as indices. Each ID is a serial number, automatically assigned to the image in order in which the image is stored. The keyword table list stores keywords or descriptors assigned to images, using IDs as indices.

The keywords assigned to the image include those originally assigned to the image and those obtained from an external database such as a file system when the image is stored. Examples of the keywords include a title, a genre, a description of appearance and the like of the image. The image table list and the keyword table list may be combined into one data table list.

In the ad DB 42 are stored an advertisement table list and a keyword table list (both not shown) together with a plurality of advertisements. Each advertisement is composed of one or more images, a URL (Uniform Resource Locator) and the like. The advertisement table list stores file names of the advertisements using IDs as indices. Each ID is a serial number automatically assigned to the advertisement in order in which the advertisement is stored. The keyword table list stores keywords assigned to the advertisements, using IDs as indices.

The keywords assigned to the advertisement include those originally assigned to the advertisement and those obtained from an external database such as a file system when the advertisement is stored. Examples of the keywords include a title, a genre, a description of appearance and the like of the advertisement. The advertisement table list and the keyword table list may be combined into one data table list.

The communication I/F 35 is, for example, a modem or a router. The communication I/F 35 controls communication protocol suitable for the Internet 12, and communicates data via the Internet 12. The communication I/F 35 functions as a receiving section through which the image is received, and also as a transmitting section through which data (the input image, the related image and the advertisement) processed in the server 11 is transmitted to the monitor 15 of the client terminal 13. The data received through the communication I/F 35 is temporarily stored in the RAM 33.

When the image is input to the server 11, the image feature extractor 36 analyzes the input image, and extracts a main subject of the input image. In this example, the main subject is a person. The person is extracted by the presence of a human face. To extract a human face, methods using red eye detection described in U.S. Patent Application Publication No. 2005207649 (corresponding to Japanese Patent Laid-Open Publication No. 2005-267512) and the like may be used. Other well-known techniques such as pattern matching and skin tone detection may be used for the human face extraction.

The image feature extractor 36 recognizes a facial expression of the extracted face and obtains the recognized facial expression as the feature quantity. To recognize facial expressions, techniques using Hidden Markov Model (HMM) disclosed in Japanese Patent Laid-Open Publication No. 10-255043 and the like may be used.

The image feature extractor 36 obtains items concerning the extracted face, for example, the size of the face, and items around the extracted face, for example, a hair style and an accessory as the feature quantities. Any known technique may be used to obtain the items concerning the extracted face and the items around the extracted face, and detailed expressions thereof are omitted.

The keyword obtaining section 37 searches a personal name table list (not shown) stored in the HDD 34 based on the feature quantity of the input image, and obtains a keyword of the input image. In the personal name table list, the feature quantities and keywords such as personal names and others (for example, facial expressions, the sizes of the faces, hairstyles and accessories) corresponding to feature quantities are associated with each other and stored.

The related image retriever 38 searches the image DB 41 based on the keyword obtained by the keyword obtaining section 37, and retrieves the image related to the keyword as the related image.

The image feature extractor 36 analyzes the related image and extracts a human face therefrom. The image feature extractor 36 obtains the items concerning the extracted face, for example, a facial expression and the size of the face, and the items around the extracted face, for example, a hairstyle and an accessory, as the feature quantities.

The keyword obtaining section 37 searches the personal name table list stored in the HDD 34 and obtains the personal name and the like corresponding to the feature quantity of the related mage as a keyword of the related image. It should be noted that two table lists may be used; one for the input image and the other for the related image.

The ad retriever 39 searches the ad DB 42 based on the keyword of the input image and retrieves the advertisement. To be more specific, the ad retriever 39 retrieves all the advertisements associated with the keywords coinciding with the keyword of the input image. In a case that there are multiple keywords for the input image, advertisements are searched for each keyword and retrieved.

In a case that a plurality of the advertisements are retrieved, the number of the advertisements is narrowed down based on the keyword of the input image and the keyword of the related image. To be more specific, an advertisement associated with a keyword that coincides with the keyword of the relative image, but not with the keyword of the input image, is retrieved.

In a case that the keywords of the related image are “A”, “B” and “C”, and the keywords of the input image are “A”, “B” and “D”, the advertisement associated with the keyword “C” is selected. For example, advertisements associated with two keywords “A” and “B”, and advertisements associated with three keywords “B”, “D” and “E” are excluded since the advertisements are not associated with the keyword “C”. On the other hand, an advertisement associated with the keyword “C” such as an advertisement associated with two keywords “A” and “C” and an advertisement associated with three keywords “A”, “B” and “C” are selected since the advertisements are associated with the keyword “C”.

If multiple advertisements remain in spite of the narrowing, an advertisement having a highest score in a predetermined rating based on access frequency or investment value, or a top hit in the search is selected.

The input image, the related image retrieved using the input image as the search key, the keywords of the input image and the related image obtained by the keyword obtaining section 37, and the advertisements retrieved by the ad retriever 39 are transmitted to the client terminal 13 via the Internet 12.

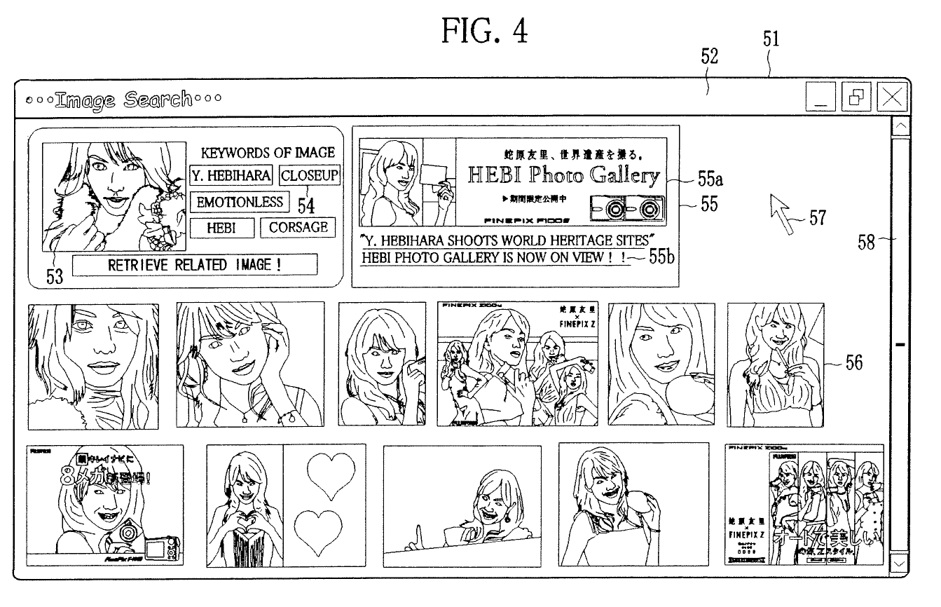

In FIG. 4, a search result screen 51 is displayed on the monitor 15. On a window 52 of the search result screen 51 are arranged an input image 53 or query image, its keywords 54 or descriptors such as “Y. Hebihara”, “closeup”, “Hebi”, “emotionless” and “corsage”, an advertisement 55 and related images 56.

On the window 52 is displayed a pointer 57 used for selection operations. The pointer 57 moves on the window 52 in accordance with the operation of the mouse 16.

The advertisement 55 is composed of an image 55a and a hyperlink 55b. The hyperlink 55b is associated with a URL that provides a location of a linked web page. Placing the pointer 57 on the hyperlink 55b and clicking the mouse 16 displays the linked web page on the monitor 15.

The related images 56 are arranged from the upper left to the lower right in descending order of a degree of association with the input image. For example, the degree of association increases as the number of common keywords between the input image and the related image increases.

By placing the pointer 57 on the related image 56 and clicking the mouse 16, the related image 56 as the input image is transmitted to the server 11, and the above-described search is carried out.

The right end of the window 52 is provided with a vertical scrollbar 58 used for scrolling the screen. Placing the pointer 57 on the scrollbar 58 and dragging it down with the operation of the mouse 16 scrolls the screen. Scrolling the screen displays the rest of the related images and the like that have not been displayed.

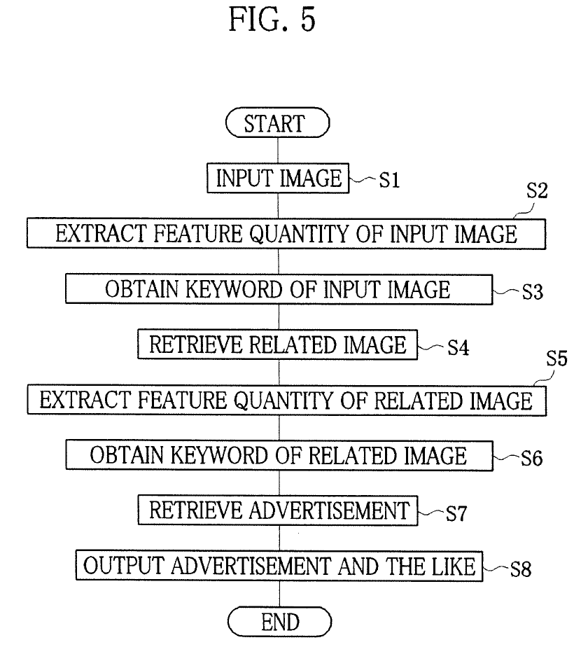

Next, with reference to a flowchart of FIG. 5, processing steps of the above embodiment are described. With the operation of the operating section of the client terminal 13, an image is input to the client terminal 13 from an external input device such as the digital camera 19 or the like. This input image 53 as the search query image is transmitted to the server 11 via the Internet 12 (S1). In the server 11, the received image is stored in the RAM 33.

The input image stored in the RAM 33 is transmitted to the image feature extractor 36. A feature quantity of the input image is extracted by the image feature extractor 36 (S2), and stored in the RAM 33.

The feature quantity of the input image is read from the RAM 33 and transmitted to the keyword obtaining section 37. The keyword obtaining section 37 refers to the personal name table list stored in the HDD 34 and obtains one or more keywords based on the feature quantity of the input image (S3). The obtained keywords are stored in the RAM 33.

The keyword stored in the RAM 33 is read by the related image retriever 38. Based on the keyword, the related image retriever 38 accesses the image DB 41 and retrieves the related image (S4). The retrieved related image is stored in the RAM 33.

Next, the related image is read by the image feature extractor 36. A feature quantity of the related image 56 is extracted by the image feature extractor 36 (S5), and stored in the RAM 33.

The feature quantity of the related image is read from the RAM 33 and transmitted to the keyword obtaining section 37. The keyword obtaining section 37 refers to the personal name table list stored in the HDD 34 and obtains one or more keywords based on the feature quantity of the related image (S6). The obtained keywords are stored in the RAM 33.

The keywords of the input image and the keywords of the related image are read from the RAM 33 and transmitted to the ad retriever 39. The ad retriever 39 accesses the ad DB 42 and retrieves the advertisement based on the keywords of the input image and the keywords of the related image (S7). The retrieved advertisement is stored in the RAM 33.

The image input to the server 11, the keywords of the input image obtained by the keyword obtaining section 37, the related image retrieved by the related image retriever 38, the keywords of the related image obtained by the keyword obtaining section 37 and the advertisement obtained by the ad retriever 39 are read from the RAM 33 and transmitted to the Internet 12 through the communication I/F 35 (S8).

The input image, the related image, the keywords of the input image and the related image, and the advertisement are received by the client terminal 13 via the Internet 12. The input image, the related image, their keywords and the advertisement are stored in the RAM 23 of the client terminal 13.

As shown in FIG. 4, the input image 53, the keywords 54 of the input image 53, the related images 56 and the advertisement 55 are displayed on the monitor 15 of the client terminal 13.

As described above, since the advertisement 55 is retrieved based on the feature quantity of the input image 53 transmitted to the server 11, the advertisement related to the input image is displayed even if the keyword is not assigned to the input image. Since the advertisement is retrieved based on the feature quantity extracted from the image, other additional information such as GPS information is unnecessary. Since the advertisement is retrieved based on the feature quantities of the input image and the related image, the advertisement highly relevant to the searched related image is displayed on the monitor 15 of the client terminal 13.

### Second Embodiment

In the first embodiment, the advertisement attaching apparatus which searches the related image and the advertisement based on a human face in the input image is described as an example. Alternatively, the related image and the advertisement may be searched based on composition (scene types) of the input image.

When the server 11 receives an image, the image feature extractor 36 analyzes the input image and extracts a feature color and a difference in color density (edge), that is, elements of the composition, as the feature quantities. To extract the feature color from the input image, for example, the color having the largest number of pixels or the color covering the largest area is extracted. A feature color may be extracted based on its appearance frequency as disclosed in Japanese Patent Laid-Open Publication No. 10-143679. Alternatively, multiple colors may be extracted. For example, a technique described in Japanese Patent Laid-Open Publication No. 2005-096334 may be used for extracting composition.

The keyword obtaining section 37 uses the elements of the composition as the feature quantities. The keyword obtaining section 37 searches a composition table list (not shown) stored in the HDD 34 based on the feature quantity, and obtains the name of the composition corresponding to the feature quantity as a keyword. In the composition table list are stored the feature quantities and names of composition, for example, the sea, the night sky and the like such that the feature quantities and the names of the composition are associated with each other.

The image feature extractor 36 analyzes the related image and extracts its element of the composition as a feature quantity. The keyword obtaining section 37 searches the composition table list stored in the HDD 34 and obtains the name of the composition corresponding to the feature quantity of the related image as a keyword. It should be noted that other configurations are similar to those of the first embodiment. The processing steps and the effects are also similar to those described in the first embodiment, so the descriptions thereof are omitted.

### Third Embodiment

Related images and advertisements may be searched and output based on a product contained in the input image.

The image feature extractor 36 analyzes the input image and extracts a shape, a pattern and a color of a product contained the input image as feature quantities. To extract the shape and the pattern, a well-known technique such as pattern matching may be used. The shape of the product is extracted prior to the extraction of the color thereof. The color of the extracted shape is extracted similar to the second embodiment.

The keyword obtaining section 37 searches a product table list (not shown) stored in the HDD 34 based on the extracted feature quantity and obtains a corresponding product name as a keyword. In the product table list, the feature quantities and the product names such as Coca Cola (registered trademark) and Suntory Oolong Tea (registered trademark) are associated with each other and stored.

The image feature extractor 36 analyzes the relative image and extracts the shape, the pattern and the color of the product as feature quantities. Based on the feature quantity of the related image, the keyword obtaining section 37 searches the product table list stored in the HDD 34 and obtains a corresponding product name as the keyword. Other configurations are similar to those of the first embodiment and the descriptions thereof are omitted.

### Fourth Embodiment

Related images and advertisements may be searched and output based on a color description term of the input image.

The image feature extractor 36 analyzes the input image and extracts multiple colors and obtains a combination of colors as a feature quantity. The colors are extracted in descending order from the color with the largest number of pixels or the color covering the largest area. The colors may be extracted in order based on the appearance frequency thereof as described in Japanese Patent Laid-Open Publication No. 10-143679.

The keyword obtaining section 37 searches a table list of color description terms (not shown) stored in the HDD 34 based on the extracted feature quantity, and obtains, as a keyword, a word describing a color description term corresponding to the feature quantity. In the table list of color description terms, feature quantities and corresponding color description terms are associated with each other and stored. For example, a combination of dark red and dark blue is associated with a word “dignified”, and a combination of middle light gray colors is associated with a word “natural” or “ecological”.

The image feature extractor 36 analyzes a related image and extracts multiple colors and obtains a combination of colors as the feature quantity. The keyword obtaining section 37 searches the table list of color description terms in the HDD 34 based on the feature quantity of the related image, and obtains, as a keyword, a color description term corresponding to the feature quantity. Other configurations, processing steps and effects are similar to those of the first embodiment.

### Fifth Embodiment

Related images and advertisements may be searched and output based on a letter (character) in text contained in the input image.

The image feature extractor 36 analyzes the input image and extracts a letter in text as a feature quantity. To extract a letter, a layout analysis is performed. In the layout analysis, a text zone of the input image is segmented, and then each letter of the text is fetched. An edge, a contour, direction contributivity and the like are extracted for each letter, and they are matched with a previously-registered reference pattern. Several matched reference patterns are output as potential feature quantities. Of those, inappropriate patterns are determined by context and omitted, and a remaining pattern is converted into text data as the feature quantity.

The keyword obtaining section 37 searches a text table list (not shown) stored in the HDD 34 based on the feature quantity, and obtains, as a keyword, text data corresponding to the feature quantity. In the text table list, the feature quantities and the text data are associated with each other and stored.

The image feature extractor 36 analyzes the relative image and extracts a letter as a feature quantity. The keyword obtaining section 37 searches the text table list stored in the HDD 34 based on the feature quantity of the related image and obtains the corresponding text data as the keyword. Other configurations, processing steps and effects are similar to those in the first embodiment.

In each of the advertisement attaching apparatuses of the above embodiments, the related image and the advertisement are searched based on a criterion, for example, a human face in the first embodiment. These advertisement attaching apparatuses may be combined into one apparatus. In this case, multiple criteria may be used selectively or inclusively. To use the multiple criteria selectively, the criteria may be selected automatically, for example, randomly, or based on instructions from the operating section 18.

To use the multiple criteria inclusively, it is necessary to prioritize the criteria. Once the feature quantity of the input image is extracted, the extraction of the feature quantity of the lower priority is omitted. For example, the image feature extractor 36 attempts to extract composition from the input image when a human face is not extracted. When composition is not extracted, the image feature extractor 36 attempts to extract a shape, a pattern and a color of a product contained in the input image. If a shape, a pattern and a color of a product are extracted, extraction of a color combination or text is not performed. By attempting to extract feature quantities in descending order of importance of the criterion, the feature of the input image is correctly comprehended. In addition, failures in extracting the feature quantity are reduced.

In the above embodiments, the ad retriever 39 retrieves the advertisement based on the keyword corresponding to the feature quantity of the input image and the keyword corresponding to the feature quantity of the related image. Instead, a keyword may be obtained based on both the feature quantity of the input image and the feature quantity of the related image, and the advertisement may be retrieved based on this keyword. In this case, the keyword obtaining section 37 obtains keyword(s) based on the feature quantity of the input image and keyword(s) based on the feature quantity of the related image. Then, for example, a common keyword between the input image and the related image is obtained as the keyword for retrieving the advertisement.

In the above embodiments, the image feature extractor 36 analyzes the input image and extracts the feature quantity such as a human face, a facial expression, the size of the face, a hairstyle, an accessory, composition, a shape, a pattern and a color of a product, a color combination and text. In a case that the feature quantity is previously extracted such as a so-called stock photo service provided on the Internet, the extracted feature quantity is directly obtained.

In the above embodiments, the advertisement attaching apparatus is built in the server 11 connected to the internet 12, which is made accessible to any user. For personal use, the advertisement attaching apparatus may be built in a personal computer, for example. In this case, the ad retriever accesses an external server having an advertisement database and retrieves an advertisement therefrom.

It is possible in the above embodiments to obtain the effect of the present invention specifically when the previously stored numerous related images are photographs of a person, article, landscape or the like, namely a great number of variants of images of common subjects. Also, the image 55a in the advertisement 55 may be not only a single photograph but also an image of any form previously created according to preference of an advertiser, for example, a composite image formed from plural photographs. Furthermore, the related images and/or the image 55a in the advertisement 55 may have forms other than photographs, for example, a pattern, icon, banner and the like.

Various changes and modifications are possible in the present invention and may be understood to be within the present invention.

What is claimed is:

1. An advertisement attaching apparatus connected to a client terminal via the Internet, comprising:
an image feature extractor for extracting a first feature quantity from an image sent from said client terminal;
a related image retriever for retrieving a related image related to said image based on said first feature quantity;
an advertisement retriever for retrieving an advertisement related to said image and/or said related image; and
a transmitting section for transmitting said related image and said advertisement to said client terminal.

2. The advertisement attaching apparatus of claim 1, wherein said image feature extractor extracts a second feature quantity from said related image, in addition to said first feature quantity.

3. The advertisement attaching apparatus of claim 2, further including a keyword obtaining section for obtaining a keyword from said first feature quantity and/or said second feature quantity, wherein said advertisement retriever retrieves said advertisement from an advertisement database based on said keyword.

4. The advertisement attaching apparatus of claim 3, wherein said keyword obtaining section obtains said keyword based on said first feature quantity, and said related image retriever retrieves said related image from an image database based on said keyword.

5. The advertisement attaching apparatus of claim 3, wherein said first feature quantity or said second feature quantity is information of a human face.

6. The advertisement attaching apparatus of claim 5, wherein said keyword obtaining section uses a personal name table list in which a plurality of human faces and their names are associated with each other and stored, and obtains a name, corresponding to said human face, as said keyword.

7. The advertisement attaching apparatus of claim 3, wherein said first feature quantity or said second feature quantity is information of a product.

8. The advertisement attaching apparatus of claim 7, wherein said keyword obtaining section uses a product table list in which a plurality of products and their names are associated with each other and stored, and obtains a name, corresponding to said product, as said keyword.

9. The advertisement attaching apparatus of claim 3, wherein said first feature quantity or said second feature quantity is alphanumeric information.

10. The advertisement attaching apparatus of claim 3, wherein said first feature quantity or said second feature quantity is a combination of colors, and said keyword obtaining section uses a table list in which a plurality of color combinations and description terms suggested by said color combinations are associated with each other and stored, and obtains a description term, corresponding to said color combination, as said keyword.

11. The advertisement attaching apparatus of claim 3, wherein said advertisement retriever accesses said advertisement database which stores advertisements associated with said keywords and retrieves said advertisement.

12. An advertisement attaching apparatus connected to a server via the Internet, comprising:
an image feature extractor for extracting a first feature quantity from an input image;
a related image retriever for retrieving a related image related to said image based on said first feature quantity;
a keyword obtaining section for obtaining a keyword from said image and/or said related image;
an advertisement retriever for retrieving an advertisement from said server based on said keyword; and
a monitor for displaying said related image and said advertisement.

13. An advertisement attaching method comprising:
extracting a feature quantity of an image received from a client terminal via the Internet;
retrieving a related image related to said image;
retrieving an advertisement based on said feature quantity; and
transmitting said advertisement together with said related image to said client terminal.

14. An advertisement attaching computer-executable program comprising:
a feature quantity extracting function for extracting a feature quantity of an image received from a client terminal via the Internet;
a related image retrieving function for retrieving a related image related to said image;
an advertisement retrieving function for retrieving an advertisement based on said feature quantity; and
a transmitting function for attaching said advertisement to said related image and transmitting said related image together with said advertisement to said client terminal.
